(19) United States
(12) Patent Application Publication
(10) Pub. No.: US 2017/0136610 A1
(43) Pub. Date: May 18, 2017

(54) PIN SPANNER WRENCH WITH GRIPPING TEETH

(71) Applicant: Leon Griffin, North Charleston, SC (US)

(72) Inventor: Leon Griffin, North Charleston, SC (US)

(21) Appl. No.: 14/941,787

(22) Filed: Nov. 16, 2015

(51) Int. Cl. B25B 27/00; B25B 13/06; B25B 13/48

(52) U.S. Cl. CPC B25B 27/0028; B25B 13/481; B25B 13/06

(57) ABSTRACT

A novel pin spanner wrench with gripping teeth. A user may utilize embodiments of the present disclosure to remove the end seals on steering cylinders and trim and tilt cylinders of certain makes and models of boat engines. Gripping teeth included in embodiments of the present disclosure enable improved grip between the pin spanner wrench and the end seals on steering cylinders and trim and tilt cylinders.

### FIELD

The present disclosure relates to the field of marine mechanics' tools; in particular, an improved pin spanner wrench with gripping teeth for removing end seals on steering cylinders and trim and tilt cylinders.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is a spanner wrench comprising a spanner body having two arms forming a U-shape, the two arms each having a pin aperture, the spanner body having a top side and a face side; a socket drive coupled to the top side of the spanner body, the socket drive defining a wrench aperture; at least one pin extending through the pin aperture of each of the two arms, the pin having a cylindrical body with a bolt head at a first end and a threaded central portion; and, a pin tooth disposed around the circumference of a second end of the at least one pin.

Another object of the present disclosure is a spanner wrench comprising a spanner body having a pin aperture on a central portion of the spanner body and two arms forming a U-shape, the two arms each having a pin aperture, the spanner body having a top side and a face side; a socket drive disposed on the top side of the spanner body, the socket drive having four walls defining a wrench aperture; a pin extending through the pin aperture of each of the two arms and the central portion, the pin having a cylindrical pin body with a bolt head at a first end and a threaded central portion; and, a pin tooth disposed around the circumference of a second end of the at least one pin.

Yet another aspect of the present disclosure is a spanner wrench comprising a spanner body having a pin aperture on a central portion of the spanner body and two arms forming a U-shape, the two arms each having a pin aperture, the spanner body having a top side and a face side; a socket drive disposed on the top side of the spanner body, the socket drive having four walls defining a wrench aperture; three pins, each pin extending, respectively, through the pin aperture of each of the two arms and the central portion of the spanner body, each pin having a cylindrical pin body with a bolt head at a first end and a threaded central portion; and, a pin tooth disposed around the circumference of a second end of each pin, the pin tooth defining a flange around the circumference of the second end of each pin, the flange extending from the circumference of the second end of each pin at an angle in the range of about 10 degrees to about 60 degrees relative to the cylindrical pin body.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is a top perspective view of a spanner wrench according to an embodiment;

FIG. 2 is a bottom perspective view of a spanner wrench according to an embodiment;

FIG. 3 is a side view of a spanner wrench according to an embodiment;

FIG. 4a is a side view of a spanner wrench pin according to an embodiment;

FIG. 4b is an exploded view of a spanner wrench pin according to an embodiment.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

Embodiments of the present disclosure provide for a novel pin spanner wrench with gripping teeth. A user may utilize embodiments of the present disclosure to remove the end seals on steering cylinders and trim and tilt cylinders of certain makes and models of boat engines. Gripping teeth present in embodiments of the present disclosure enable improved grip between the pin spanner wrench and the end seals on steering cylinders and trim and tilt cylinders.

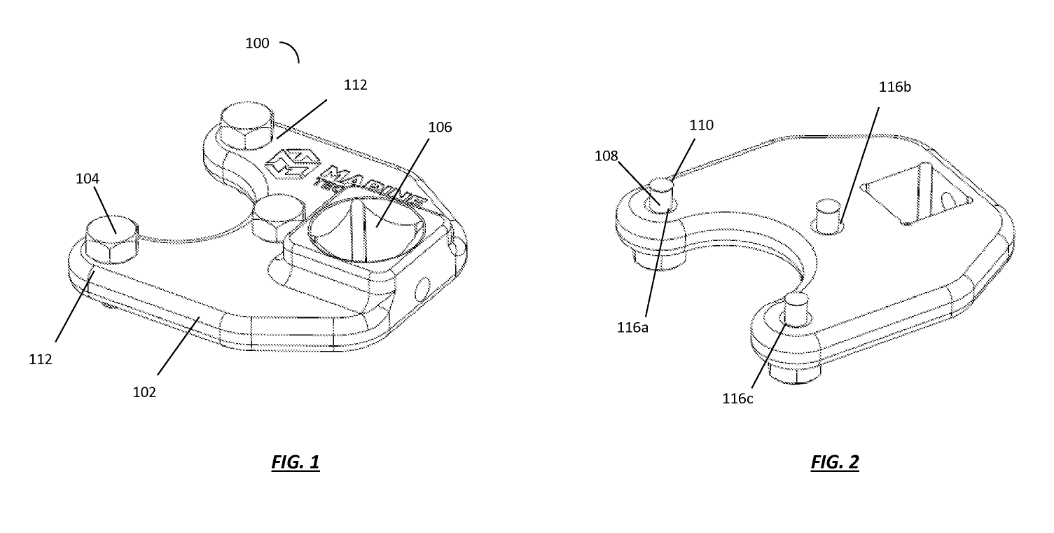

Referring now to FIGS. 1 and 2, a top perspective view of a pin spanner wrench 100 is shown. According to a preferred embodiment, a pin spanner wrench 100 has a top side (as shown in FIG. 1) and a face side (as shown in FIG. 2). Pin spanner wrench 100 has a body 102 having arms 112 forming a U-shaped opening at one end of body 102, such that body 102 is configured to fit around the shaft of a boat engine steering cylinder or a trim and tilt cylinder. Body 102 may be made of hardened stainless steel for strength and durability. Body 102 has a central portion adjacent to the U-shaped opening and a socket drive 106 at an opposite end of the U-shaped opening. Socket drive 106 has four raised side walls and an opening extending through body 102 configured to receive a socket head. Socket drive 106 may be configured in a variety of sizes, for example half an inch, to fit corresponding sized socket heads. Body 102 may have three pin apertures 116a, 116b and 116c. Pin apertures 116a and 116c may be disposed on arms 112, and pin aperture 116b may be disposed on a central portion of body 102.

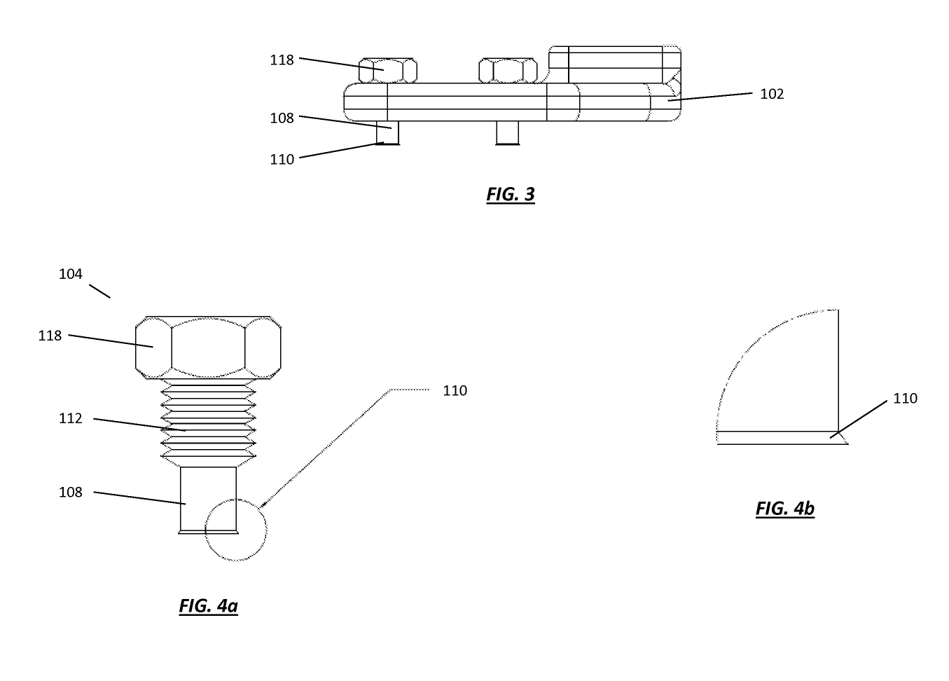

Pin spanner wrench 100 may have three or more pins 104 removably coupled to body 102 via pin apertures 116. Pins 104 may have a hex head 118, a cylinder body 108 and a pin tooth 110. Pins 104 may extend through body 102 such that hex head 118 is in contact with the top side of body 102 and cylinder body 108 extends from the face side, as shown in FIG. 3. Cylinder body 108 may have a threaded portion 120 to mechanically couple with an internal threaded portion of pin apertures 116, as shown in FIG. 4a. Alternative embodiments may exist without threaded portion 120 where pins 104 are welded directly to body 102 or are otherwise integral to body 102. Pin tooth 110 may be disposed around a circumference cylinder body 108. Pin tooth 110 may extend from cylinder body 108 to form a flange (as illustrated by the exploded view in FIG. 4b), and may extend from cylinder body 108 at an angle of about 10 degrees to about 60 degrees. Pin tooth 110 may define a circumference that is in the range of about 1% to about 20% larger than that of the circumference of the cylinder body 108. Alternative embodiments are anticipated wherein pin tooth 110 is disposed on less than the entire circumference of cylinder body 108.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention.

What is claimed is:

1. A spanner wrench comprising:
a spanner body having two arms forming a U-shape, the two arms each having a pin aperture, the spanner body having a top side and a face side;
a socket drive coupled to the top side of the spanner body, the socket drive defining a wrench aperture;
at least one pin extending through the pin aperture of each of the two arms, the pin having a cylindrical pin body with a bolt head at a first end and a threaded central portion; and,
a pin tooth disposed around the circumference of a second end of the at least one pin.

2. The spanner wrench of claim 1 wherein the pin tooth defines a flange around the circumference of a second end of the at least one pin.

3. The spanner wrench of claim 2 wherein the flange extends from the circumference of the cylindrical pin body at an angle in the range of about 10 degrees to about 60 degrees.

4. The spanner wrench of claim 2 wherein the circumference of the pin tooth is in the range of about 1% to about 20% larger than the circumference of the cylindrical pin body.

5. A spanner wrench comprising:
a spanner body having a pin aperture on a central portion of the spanner body and two arms forming a U-shape, the two arms each having a pin aperture, the spanner body having a top side and a face side;
a socket drive disposed on the top side of the spanner body, the socket drive having four walls defining a wrench aperture;
at least two pins extending through the spanner body, the at least two pins each having a cylindrical body with a bolt head at a first end and a threaded central portion; and,
a pin tooth disposed around the circumference of a second end of each of the at least two pins.

6. The spanner wrench of claim 5 wherein the pin tooth defines a flange around the circumference of a second end of each of the at least two pins.

7. The spanner wrench of claim 6 wherein the flange extends from the circumference of the cylindrical pin body at an angle in the range of about 10 degrees to about 60 degrees.

8. The spanner wrench of claim 6 wherein the circumference of the pin tooth is in the range of about 1% to about 20% larger than the circumference of the cylindrical pin body.

9. A spanner wrench comprising:
a spanner body having a pin aperture on a central portion of the spanner body and two arms forming a U-shape, the two arms each having a pin aperture, the spanner body having a top side and a face side;
a socket drive disposed on the top side of the spanner body, the socket drive having four walls defining a wrench aperture;
three pins, each pin extending, respectively, through the pin aperture of each of the two arms and the central portion of the spanner body, each pin having a cylindrical pin body with a bolt head at a first end and a threaded central portion; and,
a pin tooth disposed around the circumference of a second end of each pin, the pin tooth defining a flange around the circumference of the second end of each pin, the flange extending from the circumference of the second end of each pin at an angle in the range of about 10 degrees to about 60 degrees relative to the cylindrical pin body.

10. The spanner wrench of claim 9 wherein the circumference of the pin tooth is in the range of about 1% to about 20% larger than the circumference of the cylindrical pin body.
